(19) United States
(12) Patent Application Publication
(10) Pub. No.: US 2006/0272158 A1
(43) Pub. Date: Dec. 7, 2006

(54) Blade actuating stop

(76) Inventor: James Lee Williams, Texas City, TX (US)

Correspondence Address: William P. Glenn, Jr., Suite 205, 2102 Mechanic Street, Galveston, TX, 77550, US

(21) Appl. No.: 11/430,112

(22) Filed: May 8, 2006

Related U.S. Application Data
(60) Provisional application No. 60/687,004, filed on Jun. 4, 2005.

(51) Int. Cl. B26B 1/04

(52) U.S. Cl. 30/161

(57) ABSTRACT

This invention relates to an actuator in a knife that controls the movement of the blade between an open and alternatively closed position. The knife generally consists of a blade having a tang extending outwardly from the blade; a handle having a guide; a bar connecting the tang and the handle; an actuator engaging the blade, wherein movement of the actuator is limited by the guide of the handle. In another embodiment, the handle includes an arrestor which impedes the movement of the blade or actuator until sufficient force is applied to break past the arrestor. Generally, in the present invention, force must be applied to the actuator to initiate movement of the blade whereupon the actuator moves into a position to stop the blade from further movement.

### CROSS REFERENCE

This patent application claims priority to U.S. Provisional Application No. 60/687,004 filed Jun. 4, 2005 entitled “Knife Blade Arrestor.”

### BACKGROUND OF INVENTION

1. Field of Invention

Generally, this invention relates to cutlery implements which are foldable or otherwise retractable into the handle to protect the blade while not in use. Specifically, this invention relates to implements in which a means is provided for positively moving the blade from the handle and locking the blade in either in an open or closed position.

2. Description of Related Art

In the cutlery industry, a folding or sliding knife includes a housing or handle to support the blade in the open position and for receiving the blade in the closed position. Challenges lie in the starting and stopping the movement of a knife blade as well as keeping a knife blade in a desirable position, such as open, locked or closed positions.

Controlling movement of a pivoting knife blade is generally known and examples of such control can be found in Collins U.S. Pat. No. 5,815,927, Glesser U.S. Pat. No. 6,918,184, Leatherman's flipper knife models E306x and E307x, Onion U.S. Pat. Nos. 6,591,504, and 6,145,202, and Onion U.S. Patent Application Publication 2005/0132576. It is generally known how to lock a knife blade when in the open position. Examples of such locking mechanism are found in Neely U.S. Pat. No. 5,060,379 and Wiethoff U.S. Pat. No. 4,404,748.

The actuator and stop mechanism of the present invention overcomes the various deficiencies of folding knives and opening and closing mechanisms presently known in the knife and cutlery industry by providing positive opening and stopping assistance while enabling such opening and closing to be performed with only a single hand of the user.

### BRIEF SUMMARY OF THE INVENTION

This invention generally provides for a folding knife mechanism comprising a blade, a handle for receiving and supporting the blade and an actuator located within the handle that engages with the blade and provides positive assistance for opening the blade. The mechanism generally includes an actuator coupled to a guide formed in the interior of the handle. The actuator is substantially coplanar to said blade and pushes against the blade to move it from a closed to an open position. Generally, in the present invention, force, typically from the user, is applied to the actuator to initiate movement of the blade whereupon the actuator moves into a position to stop the blade from further movement, hence the name of the invention, blade actuating stop.

An arrestor may be incorporated into the knife to prevent accidental opening of the blade and requires further positive force to begin movement of the blade. The arrestor is attached to the handle or sub-components of the handle and positioned to interfere with the movement of the blade or actuator until sufficient force is applied to the blade or actuator to break past the arrestor.

Likewise, a locking means, such as a lock situated in the handle, may be provided to prevent accidental closing of the blade. The blade of the present invention, when in an open position, is securely held in position between the lock and the actuator.

### BRIEF DESCRIPTION OF DRAWINGS

FIG. 1 depicts a profile view of the prior art with the blade in a closed position.

FIG. 2 depicts a profile cutaway view of the prior art with the blade in a closed position.

FIG. 3 depicts a profile cutaway view of the prior art with the blade in a partial open position.

FIG. 4 depicts a profile cutaway view of the prior art with the blade in a fully open and locked position.

FIG. 5 depicts a profile view of an embodiment of the present invention with a blade in a closed position and an exposed digit tab of a blade actuating stop.

FIG. 6 depicts a cutaway profile view of an embodiment of the present invention with a blade in a closed position and an exposed digit tab of a blade actuating stop.

FIG. 7 depicts a cutaway profile view of an embodiment of the present invention with a blade in a partial open position engaged with a blade actuating stop.

FIG. 8 depicts a cutaway profile view of an embodiment of the present invention with a blade in a partial open position and a blade actuating stop operatively coupled to an arcuate guide groove and positioned to stop blade movement.

FIG. 9 depicts a cutaway profile view of an embodiment of the present invention with a blade in a full open and locked position between a blade actuating stop and a liner lock.

FIG. 10 depicts a cross sectional view of an embodiment of the present invention with a blade actuating stop coupled to a guide rail.

FIGS. 11a and 11b depict cutaway profile views of an embodiment of the present invention with a blade actuating stop, spring and arrestor in the form of a tab.

FIGS. 12a and 12b depict cutaway profile views of an embodiment of the present invention with a blade actuating stop and spring.

FIGS. 13a and 13b depict cutaway profile views of an embodiment of the present invention with a blade actuating stop operatively coupled to a linear guide groove.

FIGS. 14a and 14b depict cutaway profile views of an embodiment of the present invention with an arrestor in the form of a tab to impede blade movement.

FIG. 15 depicts a cutaway profile view of an embodiment of the present invention with an arrestor in the form of an axially compressive member to impede blade movement.

FIGS. 16a and 16b depict cutaway profile views of an embodiment of the present invention with an arrestor in the form of a spindled flexible shaft to impede blade movement.

### DETAILED DESCRIPTION

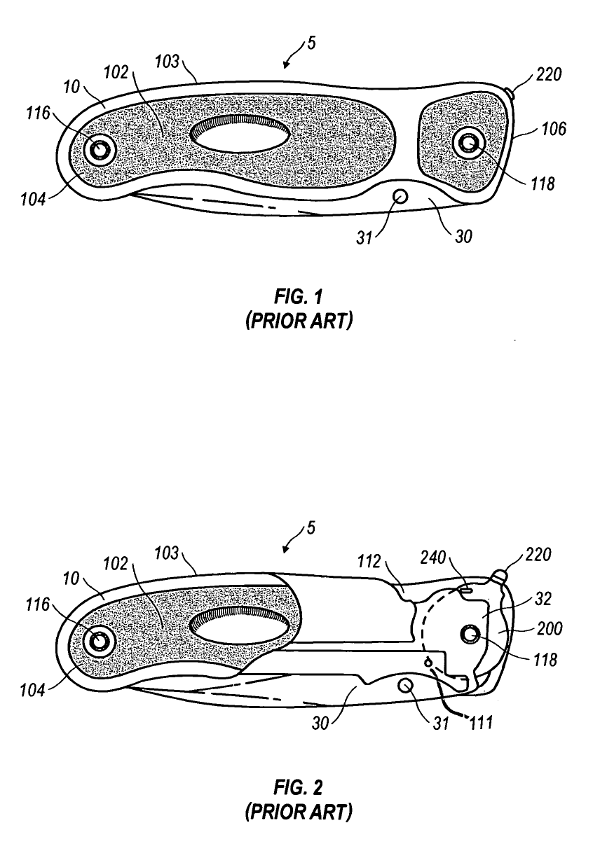

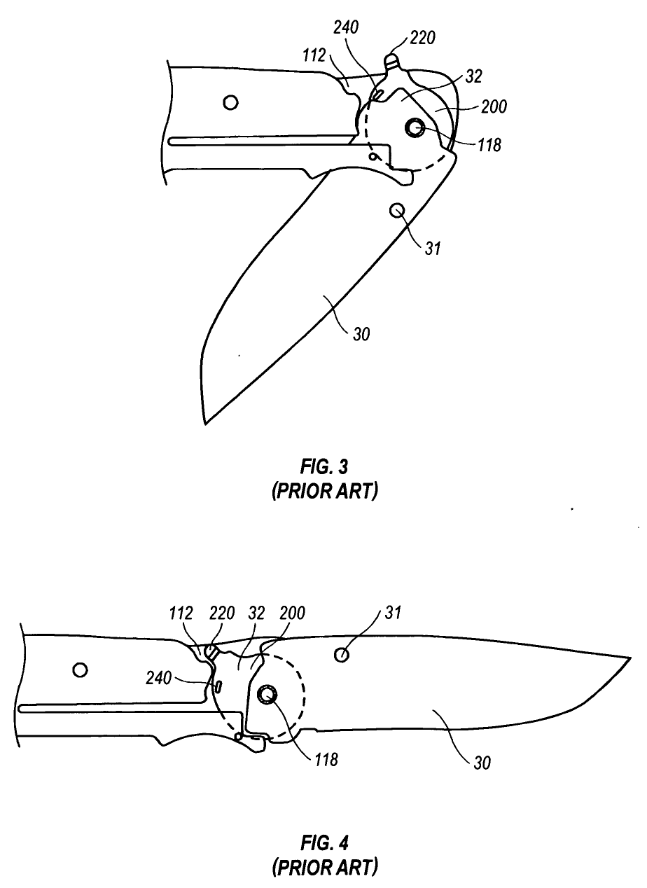

To appreciate the present invention an understanding of the prior art is in order. Referring to FIGS. 1 through 4, the prior art folding knife 5 provides for a handle 10 with side parts 102, a bottom 103, rear end 104 and a front end 106. Fasteners 116 hold the side parts 102 of handle 10 together. See FIG. 1. A central cavity 112 is formed in the handle 10 to receive a blade 30. See FIG. 2. An actuator plate 200 and a blade 30 pivotally connected by a bar 118 to a handle 10. See FIGS. 2 through 4. A tang 32 projects from one end region of blade 30. See FIGS. 2 through 4. The actuator plate 200 and blade 30 are pivotably connected to the handle 10 by a common bar 118 such that actuator plate 200 is disposed between one side of handle 10 and blade 30. See FIGS. 1 through 4.

The actuator plate 200 includes a finger tab 220 and a tang contactor 240. See FIGS. 2 through 4. Finger tab 220 projects away from the periphery of the actuator plate 200 and extends above a portion of handle 10 through a part of its arc of rotation about bar 118. See FIGS. 2 through 4. Tang contactor 240 projects away from one side of the actuator plate 200 to engage tang 32 when actuator plate 200 is rotated through a portion of its arc of rotation about bar 118. See FIGS. 2 through 4.

Movement of blade 30 out of the central cavity 112 occurs when user force applied to finger tab 220 causes actuator plate 200 to rotate about bar 118 to engage and push tang contactor 240 against tang 32. The blade 30 is pushed towards an open position while tang contactor 240 is engaged against tang 32. This positive push of the blade by tang contactor 240 continues until finger tab 220 rotates into handle 10. A thumb pin 31 attached to and projecting from blade 30 provides an alternative means to open a blade 30. See FIGS. 1 through 4.

Variations in the required spacing between actuator plate 200, blade 30 and handle 10 affect the amount of effort required to move blade 30 out of handle 10 as well as the effectiveness of tang contactor 240 engaging tang 32. The arc of actuator plate 200 rotation and amount of force required to move blade 30 is dependent upon the placement of the finger tab 220 in relation to bar 118. The larger the distance between bar 118 and finger tab 220, the greater the leverage to move blade 30 out of handle 10 but at the increased risk of finger tab 220 become entangled in articles of clothing or other objects which may further cause inadvertent movement of blade 30. Effective engagement of tang contactor 240 against tang 32 requires proper alignment of the pivotal connection of actuator plate 200 against blade 30 by bar 118. Wear of tang contactor 240 or bar 118 reduces the effectiveness of the engagement between the tang contactor 240 and tang 32. Tang contactor 240 may ride over and slide against tang 32 if the distance between blade 30, handle 10 and actuator plate 200 deviates from the desired tolerances and/or by virtue of excessive wear of the tang contactor 240 itself. The present invention overcomes these issues as described below.

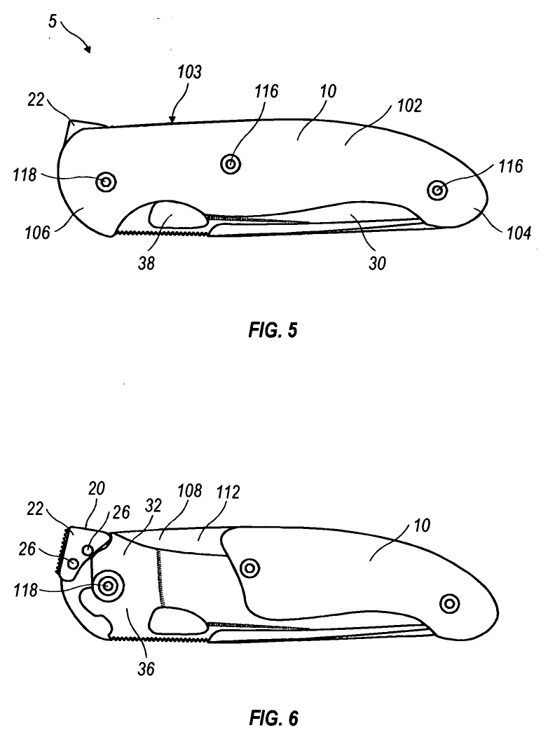

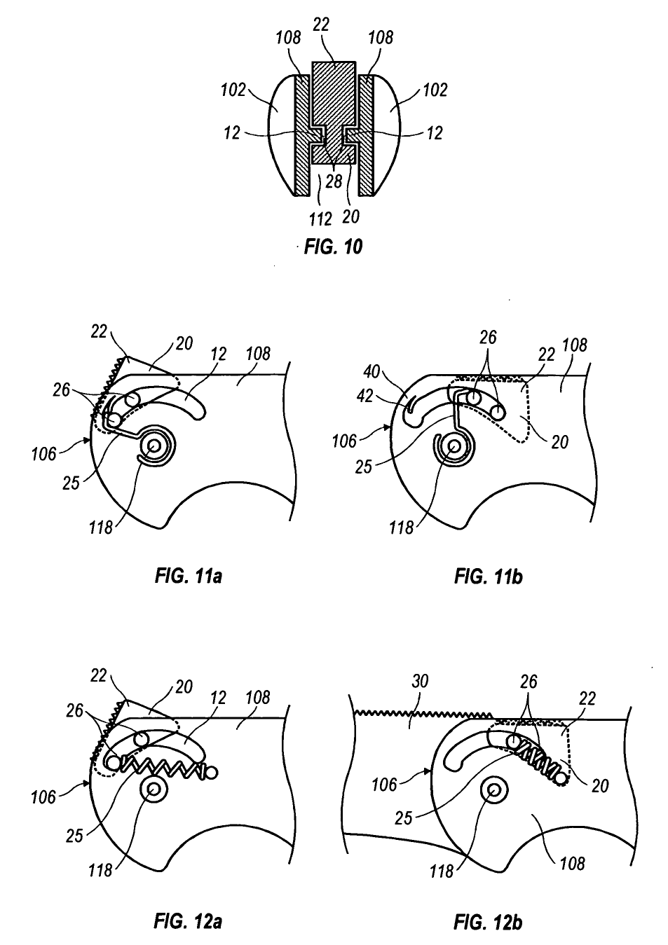

The present invention of a knife 5 generally includes a handle 10 with a bottom 103, rear end 104 and a front end 106. See FIG. 5. A central cavity 112 is formed in handle 10 to receive blade 30. See FIGS. 6 and 10. The interior of the central cavity 112 is shaped according to the form of the blade 30 and forms a stop for the blade 30 when placed in the closed position. In one embodiment, handle 10 includes side parts 102 and liners 108. See FIGS. 6 through 9. Each side part 102 and liner 108 has a plurality of holes 114 that receive fasteners 116 which secure side parts 102 together and an opening for a pivot of bar 118. See FIGS. 5, 8 and 9.

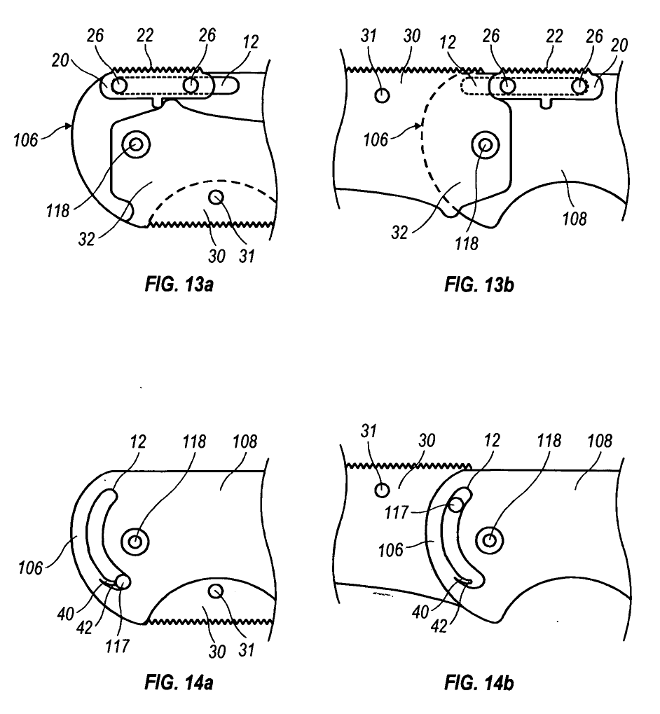

The blade 30 has a distal end 34 and a proximal end 36, with tang 32 adjacent to the proximal end 36. See FIGS. 6 and 7. The tang 32 has a hole for receiving a bar 118. It is contemplated that blade 30 may include a thumb opener 38 which provides an alternative blade opening means. See FIGS. 5 through 9. Thumb opener 38 can be in the form of a pin 31 as shown in FIGS. 13a through 15. In addition to being an opening form in the blade 30 or a pin 31, thumb opener 38 can be in the form of a disc as known to those in the cutlery arts.

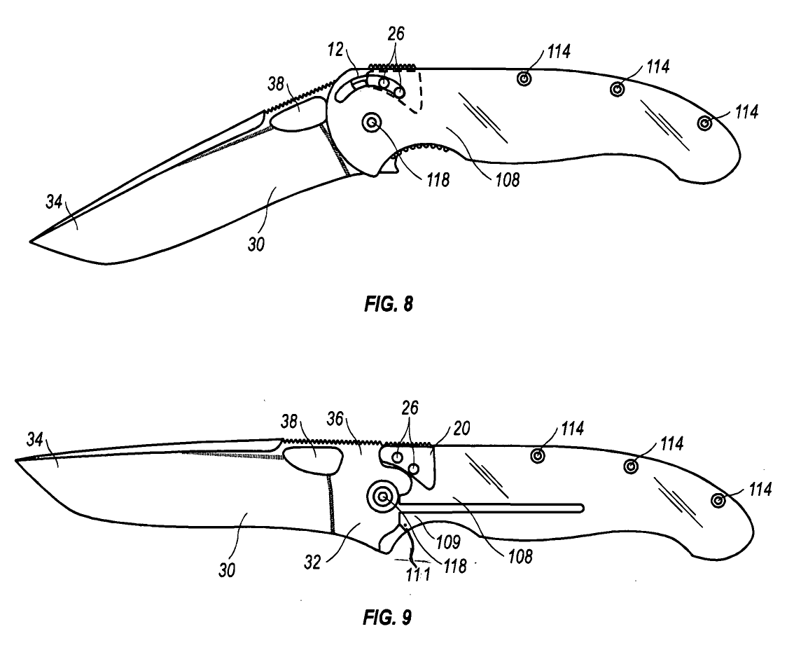

A portion of liner 108, indicated in FIG. 9 as liner portion 109 is separate from the liner 108 at the front end 106 of the handle 10 and is displaceable. Liner portion 109 is biased like a leaf spring so that it extends into the central cavity 112 of the handle 10 when the blade 30 is placed in the open position, as shown in FIG. 9. The forward end of liner portion 109 communicates with the tang 32 of the blade 30 when the blade 30 is in the open position so as to prevent folding of the blade 30 into the central cavity 112 because forward end of liner portion 109 is in the path of travel of tang 32. The user can move the forward end of liner portion 109 out of the path of travel of tang 32 to allow blade 30 to fold into the central cavity 112.

A guide 12 within handle 10 is located near tang 32 when blade 30 is in a closed position. See FIGS. 7, 8, 10, 11a, 12a, 13a, 13b, 14a through 16b. Guide 12 is operatively coupled to an actuator 20 which is coplanar with blade 30. See FIGS. 6 through 9 and 11a through 13b. As depicted in FIGS. 5 through 12b, actuator 20 includes a digit tab 22 which projects beyond a portion of handle 10 when blade 30 is in a closed position and is flush with handle 10 when blade 30 is in an open position. In another embodiment, as depicted in FIGS. 13a and 13b, actuator 20 includes a digit tab 22 that is substantially flush with handle 10 regardless of the position of blade 30.

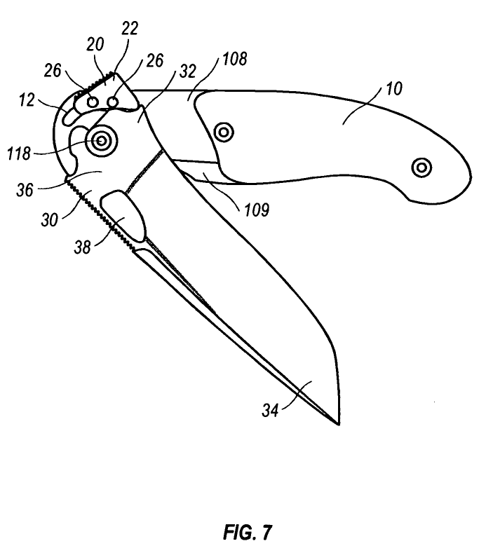

The shape of guide 12 can be arcuate, linear or a combination of the two. See FIGS. 8 and 13a. In one embodiment, guide 12 is a groove or channel formed in the liner 108. See FIG. 8. Operative coupling with actuator 20 is achieved by at least one pin 26 riding in grooved guide 12. See FIG. 8. In another embodiment, operative coupling with actuator 20 is achieved by a groove 28 formed in actuator 20 riding on guide 12 in the form of a rail. See FIG. 10. In each of the embodiments, once blade 30 is moving towards an open position, actuator 20 is moved into a position to stop blade 05 from further movement past the open position. See FIGS. 8, 11b, 12b and 13b.

The actuator mechanism 20 can be augmented with a spring 25 that imparts force to the actuator 20 and in turn blade 30. See FIGS. 11a through 12b. In the embodiments of FIGS. 11a and 11b, spring 25 urges the actuator 20 into a pre-determined position, preferably such that digit tab 22 is flush with (or in) handle 10. In FIGS. 11a and 11b, spring 25 includes at least one bend and is fixed to handle 10 (or liner 108). In FIGS. 12a and 12b, spring 25 is attached at one end to actuator 20 and handle 10 (or liner 108) at the other end, such that spring 20 is stretched when digit tab 22 extends beyond handle 10. In such an embodiment, the length of guide 12 and placement of spring 20 can be such as to generate a force that urges actuator 20 into a pre-determined position about the guide 12. See FIG. 11b. In another embodiment, the spring 25 and guide 12 are positioned in the handle 10 to align the force from spring 25 to impede movement of the actuator 20 at one end region of guide 12. See FIG. 11a.

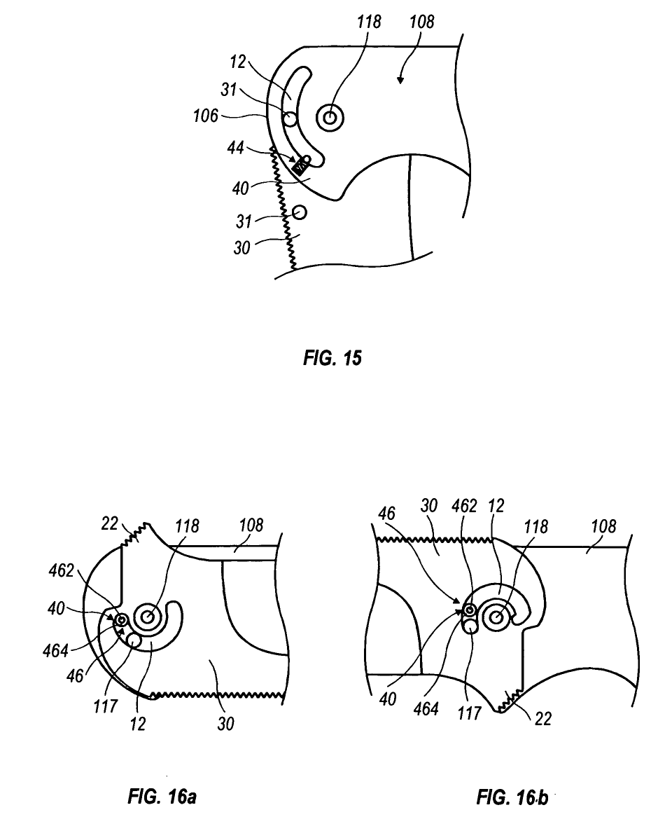

As depicted in FIGS. 11a, 11b, and 14a through 16b, an arrestor 40 is attached to the handle 10 or liner 108 and positioned to impede movement of the actuator 20 (See FIGS. 11a and 11b) or blade 30 (See FIGS. 14a through 16b) until sufficient force is applied to the actuator 20 or blade 30 to break by the arrestor 40. Arrestor 40 can be a simple tab 42 as shown in FIGS. 11b, 14a, and 14b or can be an axially compressible member 44 as shown in FIG. 15 or a spindled flexible shaft 46 as depicted in FIGS. 16a and 16b.

The break by force required to move past arrestor 40 can be varied by altering the coefficient of friction in the contact region between arrestor 40 and blade 30 or actuator 20. This can be achieved by polishing (or roughing up) at least one surface of the contact region and/or applying a layer or coating of a different material to at least one surface on the contact region.

As stated above, arrestor 40 may include a tab cut from the same material as the handle 10 or liner 108 (See FIGS. 11a, 11b, 14a and 14b). It is further contemplated that arrestor 40 in the form of a tab 42 can be manufactured from a material different from handle 10 or liner 108 and fixed (permanently or otherwise) to handle 10 or liner 108.

FIGS. 11a and 11b depict an embodiment of the present invention wherein the movement of blade 30 is limited when arrestor 40 impedes the movement of pin 26 causing actuator 20 to function as a blade stop until sufficient force is applied to either blade 30 or actuator 20 to make pin 26 break past arrestor tab 42. FIGS. 14a through 16b depict another embodiment in which a stub 117 projecting away from blade 30 is operatively coupled to a guide 12 formed in handle 10 or liner 108. In such an embodiment, tab 42 arrests the movement of blade 30 until sufficient force is applied to stub 117 to break past arrestor 40. In another embodiment, arrestor 40 includes an axially compressible member 44 attached to handle 10 or liner 108 that positions an end of arrestor 40 in the path of blade 30 or actuator 20 to impede movement of blade 30 or actuator 20 until it breaks by the arrestor 40. See FIG. 15. An axially compressible member 44 can include a spring or a compressible material, like rubber.

In yet another embodiment, arrestor 40 includes a spindled flexible shaft 46 attached to handle 10 or liner 108 in which at least a portion of spindled flexible shaft 46 is positioned to impede the movement of blade 30 until sufficient force is applied to blade 30 or actuator 20 to break past arrestor 40. See FIGS. 16a and 16b. In such an embodiment, spindled flexible shaft 46 includes a shaft 462 of flexible material, such as NITINOL, surrounded (in part or wholly) by a spindle 464 or a part thereof. It is further contemplated that shaft 462 is fixed or coupled to spindle 464. The force required to break past an arrestor including a spindled flexible shaft 46 can be varied as described above or by allowing spindle 464 or shaft 462 to rotate about the longitudinal axis defined by shaft 462.

In operation, a folding knife 05 in a closed position is grasped with the rear end 104 of the handle 10 oriented towards the user's wrist and the bottom 103 of the handle 10 resting in the palm resulting in a user's finger (typically the forefinger) being in close proximity to digit tab 22. Pressure is applied to the digit tab 22 as the finger is drawn toward the rear end 104 of handle 10, causing the actuator 20 to engage a portion of the tang 32 to rotate or slide the blade 30 out of its closed position in the central cavity 112. The blade 30 is pushed out of the central cavity 112, once the blade 30 (or actuator 20) breaks past an arrestor 40, if present, resulting in the blade 30 moving into an open position and the actuator mechanism 20 moving into position to stop the blade 30 from travel beyond the desired open position. The liner portion 109 extends into the central cavity 112 as the blade 30 clears approaches the fully open position and further becomes lodged against the tang 32, thereby preventing the blade 30 from closing.

To close the knife 05, pressure is applied to the moveable liner portion 109, dislodging the end of the lining from the tang 32, placing the liner portion 109 in linear arrangement with the lining 108. The blade 30 is then moved towards the central cavity 112. Blade 30 or actuator 20 breaks past arrestor 40, if present at blade approaches central cavity 112. In the closed position, the arrestor 40 and/or catch 111 prevents blade 30 from opening accidentally.

It will be appreciated that an actuator 20 operatively coupled to a guide 12 allows a knife designer the freedom to design the movement or throw of digit tab 22 for a particular purpose without being limited to a blade's range of motion about its pivot point as seen in conventional flipper folding knives with the finger tab fixed to the blade or detached but pivotally constrained by bar 118 as depicted in the prior art discussed above. It is contemplated that the present invention of an actuating stop and arrestor provide novel solutions to stopping and/or arresting blade 30 movement.

It will be understood that certain features and some combinations are of utility and may be employed without reference to other features and sub-combinations. This is contemplated by and is within the scope of the Claims. Since many possible embodiments may be made of the invention without departing from the scope thereof, it is to be understood that all matter herein set forth or shown in the accompanying drawings is to be interpreted as illustrative and not in a limiting sense.

What is claimed is:

1. A knife comprising:
a blade having a tang extending outwardly from said blade;
a handle having at least one guide;
a bar connecting said tang and said handle; and
an actuator engaging said blade wherein said actuator is operatively coupled to said guide of said handle such that said actuator is substantially coplanar to said blade and assists movement of said blade to an open position.

2. A knife according to claim 1, wherein said bar is pivotally connecting said tang to said handle and said guide of said blade is an arcuate groove formed in said handle concentrically positioned about said bar.

3. A knife according to claim 1, wherein said bar is pivotally connecting said tang to said handle and said guide of said blade is an linear groove formed in said handle.

4. A knife according to claim 1, wherein an arrestor is attached to said handle and positioned adjacent to said guide of said handle to impede movement of said actuator until sufficient force is applied to said actuator to break by said arrestor and further assist movement of said blade to an open position.

5. A knife according to claim 4, wherein said arrestor is a tab.

6. A knife according to claim 4, wherein said arrestor is an axially compressive member.

7. A knife according to claim 4, wherein said arrestor is a spindled shaft.

8. A knife according to claim 1, wherein a spring with two ends connects at a first end to said handle and connects at a second end to said arrestor such that said spring is positioned in said handle to generate a force that urges said actuator into a pre-determined position about said guide.

9. A knife according to claim 8, wherein said spring and guide are positioned in said handle to align said force to impede movement of said actuator at one end region of said guide.

10. A folding knife comprising:
a blade having a tang extending outwardly from said blade;
an arcuate groove formed in a handle;
a bar pivotally connecting said tang and said handle; and
an actuator engaged to said blade wherein said actuator is operatively coupled to said arcuate groove such that said actuator is substantially coplanar to said blade and assists movement of said blade to an open position.

11. A folding knife according to claim 10, wherein said actuator moves to a predetermined position along said arcuate groove to stop said blade from traveling beyond said open position.

12. A folding knife according to claim 10, wherein an arrestor is attached to said handle and positioned to extend into said arcuate groove to impede movement of said actuator until sufficient force is applied to said actuator to break by said arrestor and further assist movement of said blade to an open position.

13. A folding knife according to claim 12, wherein said arrestor is tab.

14. A folding knife according to claim 12, wherein said arrestor is an axially compressible member.

15. A folding knife according to claim 12, wherein said arrestor is a spindled shaft.

16. A folding knife according to claim 10, wherein a spring with two ends connects at a first end to said handle and connects at a second end to said actuator such that said spring is positioned adjacent to said bar to urge said actuator into a pre-determined position about said handle.

17. A folding knife according to claim 10, wherein a spring with at least one bend is connected to said handle adjacent to said bar, wherein said spring urges said actuator into a pre-determined position along said guide.

18. A knife comprising:
a blade having a tang extending outwardly from said blade;
a cavity formed in a handle to receive said blade;
a guide formed in said handle operatively coupled to said blade;
a bar connecting said tang and said handle;
an arrestor attached to said handle to impede said operative coupling between said blade and guide sufficient force is applied to said blade to break by said arrestor.

19. A knife according to claim 18, wherein a spring with two ends connects at a first end to said handle and connects at a second end to said tang such that said spring is positioned in said handle to generate a force that urges said blade into a pre-determined position about said guide.

20. A knife according to claim 18, wherein said spring and guide are positioned in said handle to align said force to impede movement of said blade at one end region of said guide.
